(19) United States
(12) Patent Application Publication
(10) Pub. No.: US 2010/0263408 A1
(43) Pub. Date: Oct. 21, 2010

(54) BODY JEWELRY SIZING SYSTEM AND METHOD

(76) Inventor: James Chae Kim, Pasadena, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/538,695

(22) Filed: Aug. 10, 2009

Related U.S. Application Data
(60) Provisional application No. 61/212,917, filed on Apr. 17, 2009.

(51) Int. Cl. A44C 15/00; A44C 27/00; B23P 19/00

(52) U.S. Cl. 63/12; 29/896.41; 29/700

(57) ABSTRACT

Provided is a method of modifying a size of body jewelry. The method includes providing body jewelry to be disposed in a body piercing orifice, wherein the body jewelry includes an exterior surface having an external size to fit securely within first body piercing orifice, providing a sizing sleeve to be disposed about the exterior surface of the body jewelry, wherein the sizing sleeve includes a hygienic material having an inward facing interior surface to be disposed about the exterior surface of the body jewelry during use and an outward facing exterior surface to contact an interior of a body piercing orifice during use, and disposing the sizing sleeve about the body jewelry, such that at least a portion of the interior surface of the sizing sleeve is disposed about at least a portion of the exterior surface of the body jewelry, wherein an external size of the sizing sleeve with the sizing sleeve disposed about the body jewelry is greater than the external size of the exterior surface of the body jewelry, and wherein external size of the sizing sleeve with the sizing sleeve disposed about the body jewelry is fits securely within a second body piercing orifice that is larger than the first the first body piercing orifice.

### PRIORITY

This patent application claims priority to U.S. Provisional Patent Application No. 61/212,917 filed Apr. 17, 2009, the entirety of which is herein incorporated by reference.

### BACKGROUND

1. Field of the Invention

The present invention generally relates to a system and method for jewelry sizing and more particularly to sleeves for modifying the size and/or fit of body jewelry.

2. Description of Related Art

Body jewelry typically includes jewelry specifically intended for use in body piercing. Body jewelry includes ornamental jewelry that is worn on all parts of the body, including but not limited to the ear, belly button, face, nose, torso, and genitalia. Body jewelry may include any variety of shapes, including but not limited to rings, plugs, barbells, or various other shapes. Typically, body jewelry is secured into a piercing or similar location. For example, in the case of a cylindrical ring worn in a person's ear, the ring may be slid into a piercing (e.g., a hole or orifice) formed in the ear such that the outside of the cylindrical ring contacts the inside of the piercing hole and is held in place by the contact between the cylindrical ring and the skin on the inside of the piercing hole.

Although a piercing hole may initially be of a small enough size to hold certain sizes body jewelry in place, the piercing hole may be expanded or stretched such that the piercing hole becomes too large to retain some smaller pieces of body jewelry. For example, the piercing hole in a person's ear may be expanded to fit larger pieces of jewelry or due to the weight, pressure, or insertion/removal of the body jewelry. Typically, once the body jewelry no longer fits the piercing hole, a larger piece of body jewelry needs to be purchased to fit within the piercing hole. Unfortunately, body jewelry is often expensive to replace and is sentimental to the person. Further, the cycle of expanding the piercing hole size will continue leading to frequent replacements of the body jewelry. Moreover, a person may not purchase a piece of body jewelry simply because it is too small for the current size of their piercing hole. For example, a person may be limited to body jewelry that fits the size of their piercing hole even though they desire to wear a certain piece of body jewelry of a smaller size. Thus, if the piercing hole is too large, a person is generally limited to the option of replacing body jewelry with another larger piece of body jewelry as the piercing hole expands, and/or a person may not purchase a certain type of jewelry that does not fit their piercing hole.

Accordingly, there is a desire to provide a technique for prolonging the useful life of body jewelry such that a person does not have to replace or discard a piece of body jewelry due the size of a body piercing hole. Such a technique may enable a person to choose between multiple sizes of jewelry, may enable them to use older jewelry that they are no longer able to wear in their current piercing hole, and may otherwise expand the lifespan of certain pieces of body jewelry.

### SUMMARY

Various embodiments of body jewelry systems and related apparatus, and methods of operating the same are described. In one embodiment, a method includes a method of modifying a size of body jewelry. The method includes providing body jewelry to be disposed in a body piercing orifice, wherein the body jewelry includes an exterior surface having an external size to fit securely within first body piercing orifice, providing a sizing sleeve to be disposed about the exterior surface of the body jewelry, wherein the sizing sleeve includes an inward facing interior surface to be disposed about the exterior surface of the body jewelry during use and an outward facing exterior surface to contact an interior of a body piercing orifice during use, and disposing the sizing sleeve about the body jewelry, such that at least a portion of the interior surface of the sizing sleeve is disposed about at least a portion of the exterior surface of the body jewelry, wherein an external size of the sizing sleeve with the sizing sleeve disposed about the body jewelry is greater than the external size of the exterior surface of the body jewelry, and wherein external size of the sizing sleeve with the sizing sleeve disposed about the body jewelry fits securely within a second body piercing orifice that is larger than the first the first body piercing orifice.

In another embodiment, provided is a body jewelry system that includes a sizing sleeve to be disposed about the exterior surface of the body jewelry, wherein the sizing sleeve includes an inward facing interior surface to be disposed about the exterior surface of the body jewelry during use and an outward facing exterior surface to contact an interior of a body piercing orifice during use.

In yet another embodiment, provided is a jewelry kit that includes a plurality of sizing sleeves to be disposed about an external surface of body jewelry, wherein each of the sizing sleeves have an inward facing interior surface to be disposed about the exterior surface of the body jewelry during use and an outward facing exterior surface configured to contact an interior of a body piercing orifice during use, wherein one or more of the plurality of sizing sleeves has a size that is different from one or more of others of the plurality of sizing sleeves.

### BRIEF DESCRIPTION OF THE DRAWINGS

Advantages of the present invention will become apparent to those skilled in the art with the benefit of the following detailed description and upon reference to the accompanying drawings in which:

FIG. 1 is a perspective view that illustrates a body jewelry sizing system in accordance with one or more embodiments of the present technique.

FIGS. 2A-2C are cross-sectional views that illustrate body jewelry in accordance with one or more embodiments of the present technique.

FIG. 3 is a cross-sectional view taken across line 3-3 of FIG. 1 that illustrates a body jewelry sizing system in accordance with one or more embodiments of the present technique.

FIGS. 4A-4D are cross-sectional views that illustrate a sleeve of the body jewelry sizing system in accordance with one or more embodiments of the present technique.

FIGS. 5A-5B are cross-section views that illustrate alternate embodiments of the body jewelry system in accordance with one or more embodiments of the present technique.

FIG. 6 is a flow chart that illustrates a method of using the body jewelry system in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique include a system and method for sizing body jewelry. In some embodiments, a sleeve is provided that can be disposed about the exterior of the body jewelry to modify its size (e.g., its gauge). In some embodiments, the sleeve includes a thickness that can increase the effective gauge of the body jewelry. In certain embodiments, the sleeve is sized and assembled to the body jewelry such that the resulting gauge is suitable for use in a body piercing hole of a given size. In some embodiments, the use of a sleeve may serve to extend the usability of the body jewelry in an expanded piercing hole. In certain embodiments, sleeves of various sizes may be provided and secured about the body jewelry to vary the effective gauge of the body jewelry as the size of the piercing hole changes (e.g., expands over time). In some embodiments, a body jewelry gauging kit includes multiple sleeves. In some embodiments a person can select a sleeve of the correct size and/or replace existing sleeves for use with body jewelry with one or more other sleeves. The above embodiments may provide for sizing of body jewelry and may also provide for sanitary use of jewelry. For example, a sleeve may replaced/exchanged when body jewelry worn by one person is moved to a piercing hole of another person.

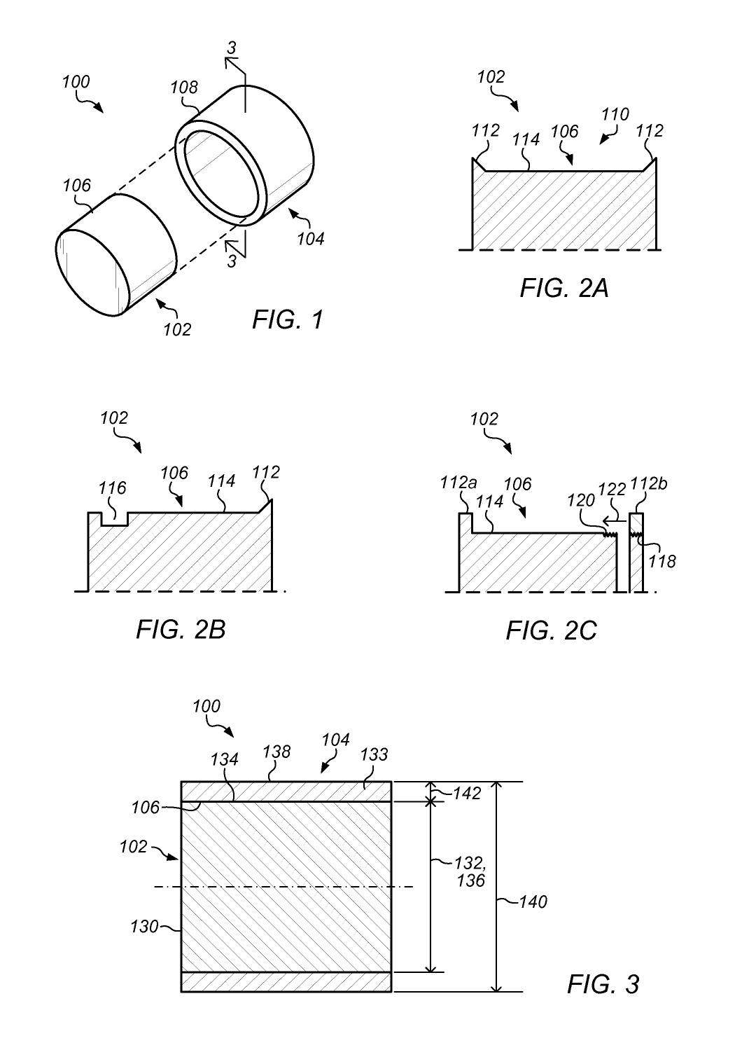

Turning now to FIG. 1, depicted is a perspective view that illustrates a body jewelry sizing system 100 (“system 100”) in accordance with one or more embodiments of the present technique. In the illustrated embodiment, system 100 includes a piece of body jewelry 102 and a sleeve 104. During use sleeve 104 may be secured about an exterior of body jewelry 102 to effectively increase the size of body jewelry 102. For example, body jewelry 102 may have an exterior surface 106 having a diameter/perimeter that is suitable for use in a piercing hole (e.g., an orifice in the skin) of a given size. The exterior size (e.g., the diameter) may be described with reference to a gauge size. Sleeve 104 may have an exterior surface 108 of a gauge that is larger than a gauge of exterior surface 106 when secured about body jewelry 102. Accordingly, with sleeve 104 secured about body jewelry 102, body jewelry 100 may have an effective gauge that is greater than the gauge of body jewelry 102. Such an embodiment may enable body jewelry 102 to be secured into a relatively larger sized piercing hole than would otherwise be possible without the use of sleeve 104.

Sleeve 104 may include a hygienic material that is conducive for use and contact with a person's skin. In one embodiment, sleeve 104 includes a non-porous material. In one embodiment, sleeve 104 includes a material that is elastic/malleable enough to conform to the shape and size of body jewelry 102. In one embodiment, sleeve 104 is formed from medical grade silicone, a plastic, or the like.

Body jewelry 102 may include various types, shapes, and sizes of jewelry to be worn by a person. In the illustrated embodiment, body jewelry 102 includes a post-type piece of jewelry having a solid cylindrical shape with a flat/smooth exterior surface along its length. Other embodiments may include any variety of jewelry types and shapes. For example, body jewelry may include rings, hoops, bar-bells, and other abstract types and shapes of jewelry that may be worn in a piercing hole.

Body jewelry 102 may include any variety of features that help to retain it in the piercing hole. For example, in an embodiment that includes a post-type piece of jewelry having a solid cylindrical (e.g., tubular) shape with a flat/smooth exterior surface along its length, such as the tube-shaped body jewelry 102 depicted in FIG. 1. In one embodiment, an external diameter of exterior surface 106 may be sized large enough to contact the interior of the skin in the piercing hole and be held in place by the contact forces (e.g., interference fit) between exterior surface 106 and the interior of the piercing hole. Other embodiments may include flanges, recesses, bends or the like that help to retain body jewelry 102 in the piercing hole, thereby inhibiting it from being dislodged from the piercing hole. FIGS. 2A-2B depict cross-sectional views of body jewelry 102 having various body jewelry surface features 110. FIG. 2A depicts double-flare shaped body jewelry 102 having flanges in accordance with one or more embodiments of the present technique. In the illustrated embodiment, body jewelry 102 includes exterior surface 106 having flanges 112 at opposite edges of body jewelry 102. Flanges 112 are separated from one another by a relatively flat/smooth portion 114 of exterior surface 106. In one embodiment, flanges 112 may help to inhibit body jewelry 120 from being dislodged from the piercing hole. For example, during use, an internal edge of the pierced hole may rest in the trough formed by flanges 112 and flat portion 114. Other embodiments may include additional flanges, a flange on one end but not the other, a flange located more toward the middle of the external surface, flanges of the same or different sizes, and the like.

FIG. 2B depicts single-flare shaped body jewelry 102 having a recess and a flange in accordance with one or more embodiments of the present technique. In the illustrated embodiment, body jewelry 102 includes exterior surface 106 having a flange 112 located at one edge of body jewelry 102, and a recess 116. Flange 112 and recess 116 are separated from one another by relatively flat/smooth portion 114 of exterior surface 106. In one embodiment, recess 116 may provide additional interference between the internal edge of the piercing hole. In another embodiment, an additional component (e.g., an O-ring) having an external diameter greater than that of surface 114 may be placed into recess 116. In such an embodiment, recess 116 and/or O-ring and flange 112 may help to inhibit body jewelry 120 from being dislodged from the piercing hole. For example, during use, an internal edge of the pierced hole may rest in the trough formed between recess 116 and/or O-ring and flange 112. Other embodiments may include additional recesses/flanges, a recess/flange on one end but not the other, a recess/flange located more toward the middle of the external surface, flanges/recesses of the same or different sizes, only one or more recesses, and the like.

FIG. 2C depicts a double-flare shaped two-piece body jewelry 102 in accordance with one or more embodiments of the present technique. In the illustrated embodiment, body jewelry 102 includes exterior surface 106 having a fixed flange 112a located at one edge of body jewelry 102, a removable flange 112b locatable at an opposite edge of body jewelry 102, and a recess/surface 114 extending there between. Removable flange 112b includes a cylindrical shaped body having internal threads 118 that may be mated with external threads 120 formed about a body of body jewelry 102 when advanced/assembled in the direction of arrow 122. When removable flange 112b is assembled to body jewelry 102, flanges 112a and 112b are separated from one another by a relatively flat/smooth portion 114 of exterior surface 106. In one embodiment, flanges 112a and 112b may help to inhibit body jewelry 120 from being dislodged from the piercing hole. For example, during use, an internal edge of the pierced hole may rest in the trough formed by flanges 112 and flat portion 114. In one embodiment, flat portion 114 may be advanced into the piercing hole and removable flange 112b subsequently attached to the body of the body jewelry 102 to secure body jewelry 102 to the piercing hole. In another embodiment, body jewelry 102 may be slid into body piercing hole with removable flange 112b already assembled to the body of body jewelry 102.

Other variations and combinations of features depicted in FIGS. 2A-2C may be provided. For example, body jewelry 102 may be provided with various combinations and locations of recesses and flanges. Further, although the depicted embodiments are cylindrical in shape and have a circular profile, other embodiments may include any variety of shapes, such as triangular profile, square profile, rectangular, or other geometry. Some embodiments may also include hollow body jewelry. In such embodiments, sleeve 104 may be secured about body 102 jewelry in a similar manner as discussed herein with regard to circular profiles.

FIG. 3 is a cross-sectional view taken across line 3-3 of FIG. 1 that illustrates a body jewelry sizing system in accordance with one or more embodiments of the present technique. In the illustrated embodiment, tube-shaped sleeve 104 is disposed about body jewelry 106. In the illustrated embodiment, body jewelry 106 includes a body 130. Body 130 includes exterior surface 106 having an external size 132. In one embodiment, external size 132 may described with reference to a gauge size and or a traditional length/diameter dimension. For example, the external size 132 may be referred to by diameter and/or gauge in accordance with the American Wire Gauge (AWG) standards. For example, external size 132 may have a diameter of about 2.588 mm (10 gauge (G)), 3.264 mm (8 G), 4.115 mm (6 G), 5.189 mm (4 G), 6.544 mm (2 G), 8.252 mm (0 G), 9.266 mm (00 G), about 12 mm, 14 mm, 16 mm, 18 mm, 22 mm, 25 mm, or more. Other embodiments may include additional features, such as flanges (e.g., protrusions), recesses, troughs, surface textures and the like, such as those described herein.

In the illustrated embodiment, sleeve 104 includes a body 133. Body 133 includes interior surface 134 having an internal size (e.g., internal diameter) 136 and exterior surface 108 having an external size (e.g., external diameter) 140. Sleeve 104 may have a thickness 142 that is the difference between internal diameter 134 and external diameter 140. In the illustrated embodiment, sleeve 104 is installed about body jewelry 102 and has an internal size 136 that is the same as external size 132 of body jewelry 102. In one embodiment, in an unbiased state, sleeve 104 may have an internal size 136 that is substantially the same as external size 132 (an internal diameter 136 that is about 95%-100% of external diameter 132). In such an embodiment, sleeve 104 may be slid onto body jewelry 102 with little to no stretching of sleeve 104. In one embodiment, in which sleeve 104 is in an unbiased state, internal size 136 may be less than the external diameter 132 (e.g., an internal diameter 136 that is about 50%, 60%, 70%, 80%, 90%, 95% of external diameter 132). In such an embodiment, sleeve 104 may be stretched and slid onto body jewelry 102. Such embodiments may provide an interference fit between body jewelry 102 and sleeve 104 that helps to inhibit the two from being separated. Internal diameter 136 may be referred to by diameter and/or gauge in accordance with the American Wire Gauge (AWG) standards. For example, internal size 136 may have a diameter of about 2.588 mm (10 gauge (G)), 3.264 mm (8 G), 4.115 mm (6 G), 5.189 mm (4 G), 6.544 (2 G), 8.252 mm (0 G), 9.266 (00 G), about 12 mm, 14 mm, 16 mm, 18 mm, 22 mm, 25 mm, or more. Internal size 136 may be assessed and determined based on external size 132. For example, a sleeve having a given internal diameter may be selected to provide an appropriate interference fit about body jewelry of a given external diameter.

External size 140 may sized appropriately to fit within the piercing hole. External size 140 may be referred to by diameter and/or gauge in accordance with the American Wire Gauge (AWG) standards. For example, external size 140 may have a diameter of about 2.588 mm (10 gauge (G)), 3.264 mm (8 G), 4.115 mm (6 G), 5.189 mm (4 G), 6.544 (2 G), 8.252 mm (0 G), 9.266 (00 G), about 12 mm, 14 mm, 16 mm, 18 mm, 22 mm, 25 mm, or more. External size 140 may be assessed and determined based on the size of the piercing hole. In one embodiment, a sleeve having a given internal diameter to fit about body jewelry and a given external diameter that will provide an appropriate interference fit within the piercing hole is selected. For example, a person may select a sleeve having with an external diameter that is the same or greater than the diameter of the piercing hole (e.g., a sleeve having an external diameter that is about 100%, 105%, 110%, 115%, 120%, 125% of the diameter of the piercing hole).

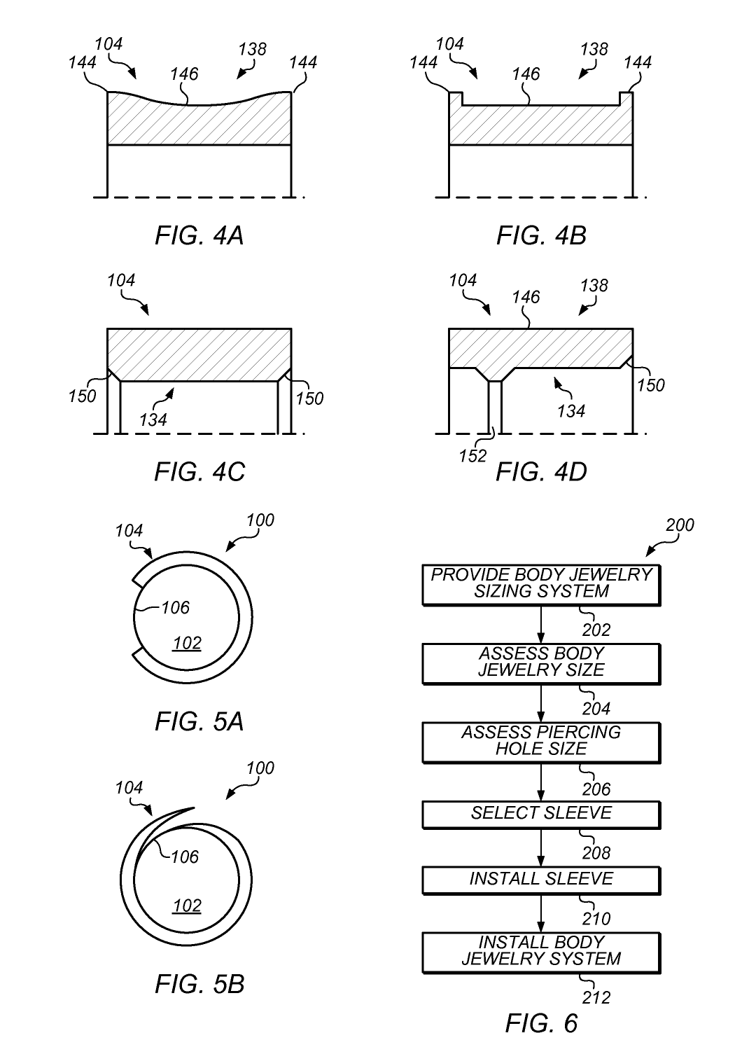

Sleeve 104 may include one or more features conducive for fit and/or securing sleeve 104 to body jewelry 102 and/or the piercing hole. FIGS. 4A-4D are cross-sectional views that illustrate sleeve 104 in accordance with one or more embodiments of the present technique. FIG. 4A depicts exterior surface 138 of double-flare shaped sleeve 104 having protrusions in accordance with one or more embodiments of the present technique. In the illustrated embodiment, sleeve 104 includes exterior surface 108 having flanges 144 (e.g., lips) at opposite edges of sleeve 102. Flanges 144 are separated from one another by a relatively smooth portion 146 of exterior surface 108. In the illustrated embodiment, smooth portion 146 includes a shallow curvature that may be complementary to the expected curvature of skin at an interior edge of the piercing hole. In one embodiment, flanges 144 may help to inhibit sleeve 104 and body jewelry 120 from being dislodged from the piercing hole during use. For example, during use, an internal edge of the pierced hole may rest in the trough formed by flanges 144 and flat portion 146. Other embodiments may include additional flanges, a flange on one end but not the other, a flange located more toward the middle of the external surface, flanges of the same or different sizes, and the like. As depicted in FIG. 4B, a similar embodiment may include a double-flare shaped exterior surface 138 having squared-off flanges 144 having a substantially flat/smooth surface 146 extending there between.

As depicted in both FIGS. 4A and 4B, interior surface 134 of sleeve 104 may be substantially smooth/flat. Such an embodiment of sleeve 104 may be conducive for use with body jewelry 102 having a complementary smooth/flat exterior surface 106, such as that depicted in FIG. 2C, or similar body jewelry 102 having at least a portion that is flat/smooth, such at that depicted in FIGS. 2A and 2C. For example, sleeve 104 of FIGS. 4A and 4B may be provided about flat/smooth surface 114 and between flanges 112, 112a and/or 112b of body jewelry 102 in FIGS. 2A-2C.

FIGS. 4C and 4D illustrate embodiments of sleeve 102 having a tube-shaped exterior and including engagement features provided at interior surface 134 of sleeve 104. FIGS. 4C and 4D depicts interior surface 134 having a chamfer/fillet 150 at both ends of sleeve 104. Such a chamfer may be shaped complementary to a portion of body jewelry 102. For example, chamfers/fillets 150 may be complementary to one or more curved/angled portions of flanges 112 of body jewelry 102 depicted in FIGS. 2A-2C. FIG. 4D also depicts interior surface 134 having a protrusion 152. Protrusion 152 may help to secure sleeve 104 to body jewelry 102 and inhibit them from being separated from one another. In the illustrated embodiment, protrusion 152 includes a lip/ridge that extends completely about interior surface 134. Such a protrusion may be shaped complementary to a portion of body jewelry 102. For example, protrusion 152 may be complementary to recesses 116 depicted in FIG. 2B. Other embodiments may include one or more protrusions and/or protrusions that extend about only a portion of interior surface 134.

FIGS. 5A and 5B are cross-sectional views that illustrate alternate embodiments of the body jewelry system 100 in accordance with one or more embodiments of the present technique. FIG. 5A illustrates an embodiment wherein sleeve 104 does not extend completely about the perimeter/circumference of body jewelry 102. For example, sleeve 104 includes a C-shaped ring that surrounds at least a majority of the perimeter of body jewelry 102. FIG. 5B illustrates an embodiment wherein sleeve 104 comprises a wrap that extends about the perimeter/circumference of body jewelry 102. For example, sleeve 104 includes a length of material that is wrapped about exterior surface 106 such that it completely encompasses a perimeter of exterior surface 106. In one embodiment, sleeve 104 may include several wraps about body jewelry 104 to provide an appropriate effective gauge for body jewelry system 100.

FIG. 6 is a flowchart that illustrates a method 200 of using the jewelry sizing system 100 in accordance with one or more embodiments of the present technique. The illustrated embodiment includes providing the body jewelry sizing system, as depicted at block 202. In one embodiment, providing the body jewelry sizing system may include providing one or both of a sleeve and body jewelry. In one embodiment, the body jewelry provided may include a previously worn piece of jewelry that does not fit as desired in a piercing hole. For example, a person may provide body jewelry that previously fit securely into a now expanded piercing hole. In one embodiment, providing body jewelry may include providing a new piece of body jewelry that a person desires to size for an existing sized piercing hole that is too large for the new piece of body jewelry.

In one embodiment, providing a sleeve may include providing a single sleeve that is sized for use with the body jewelry and the associated piercing hole. For example, a person may select or otherwise be provided with a sleeve having an internal size (e.g., an internal gauge/diameter or perimeter) that is capable of being fit securely about the external surface of the body jewelry, and having an external size (e.g., an external gauge/diameter or perimeter) that is capable of being fit securely within the associated piercing hole.

In one embodiment, the sleeve may be selected from one or a plurality of provided sleeves. For example, a vendor may provide an assortment of sleeves. In some embodiments, an assortment of sleeves may include one or more sleeves having different internal sizes, external sizes, thicknesses, colors, materials, or the like. A person may select the sleeve from this assortment. In one embodiment, an assortment of sleeves includes a plurality of sleeves wherein one or more of the plurality of sleeves has a size (e.g., internal or external gauge/diameter or perimeter) that is different from a size or shape of one or more of others of the plurality of sleeves. In one embodiment, an assortment of sleeves includes a plurality of sleeves wherein each of the plurality of sleeves has a different size (e.g., internal or external gauge/diameter or perimeter) from each of the other of the plurality of sizing sleeves. In one embodiment, an assortment of sleeves includes a plurality of sleeves wherein each of the plurality of sleeves has an external size (e.g., external gauge/diameter or perimeter) that is different from an external size of each of the other of the plurality of sizing sleeves. In one embodiment, an assortment of sleeves includes a plurality of sleeves wherein each of the plurality of sleeves has a common internal size (e.g., internal gauge/diameter or perimeter) that is the same as the other of the plurality of sizing sleeves and wherein one or more of the other of the plurality of sleeves has an external size that is different from an external size of one or more, or each, of the other of the plurality of sizing sleeves. In one embodiment, an assortment of sleeves includes a plurality of sleeves wherein each of the plurality of sleeves has a common external size that is about the same as the other of the plurality of sizing sleeves and an internal size that is different from an internal size of one or more, or each, of the other of the plurality of sizing sleeves. Providing a plurality of sleeves may enable a person to purchase a single package from which to select a correct size sleeve for their body jewelry, to replace their current sleeve when it is no longer usable, to resize the body jewelry system as the piercing hole changes in size, and/or to outfit a plurality of body jewelry with sleeves from a single package.

In one embodiment, an assortment of sleeves may be provided to a person at the time of purchasing body jewelry. For example, a user may be provided with an assortment of sleeves having a common internal size configured to fit the size of purchased jewelry and having one or more sleeves of different external sizes such that a user may exchange sleeves as the size of their piercing hole changes. In one embodiment, a body jewelry kit may include the body jewelry along with one or more sleeves. For example, single kit may include the body jewelry and an associated assortment of sleeves having a common internal size configured to fit the size of purchased jewelry and having one or more sleeves of different external sizes such that a user may exchange sleeves as the size of their piercing hole changes. In one embodiment, the kit is provided in a single package that is sold as a single item. In one embodiment the kit is provided as individual packages that are associated with one another. For example, a package containing the body jewelry may include an identifier, such as a code or color, that associates it with a complementary package containing the sleeves. For example, the package containing the sleeves may include a complementary identifier, such as a similar code or color.

In the illustrated embodiment, method 200 also includes assessing the body jewelry size, as depicted at block 204. In one embodiment, assessing the body jewelry size may include assessing an external size (e.g., external gauge/diameter or perimeter) of the body jewelry. For example, a user may compare the body jewelry to other body jewelry or a sizing chart. In one embodiment, a user may measure the body jewelry.

In the illustrated embodiment, method 200 also includes assessing the piercing hole size, as depicted at block 206. In one embodiment, assessing the piercing hole size may include assessing an internal the size of the piercing hole. For example, a user may insert various sizes of body jewelry to assess and determine the size of the hole. In one embodiment, a user may measure the piercing hole size.

In the illustrated embodiment, method 200 also includes selecting the sleeve, as depicted at block 208. In one embodiment, selecting the sleeve may include selecting a sleeve that is complementary to the external size and/or shape of the body jewelry. For example, a sleeve may be selected that is capable of being secured over the exterior surface of the body jewelry. For example, where the sleeve may be stretched over the body jewelry, a sleeve may be selected having an internal size (e.g., diameter) that is about 50%, 60%, 70%, 80%, 90%, 95% of the external size (e.g., diameter) of the body jewelry. In an embodiment in which the sleeve is not expected to stretch much, a sleeve may be selected having an internal size that is substantially the same size (e.g., about 95%-100%) of the external size of the body jewelry. In one embodiment, a sleeve is selected that has features, such as protrusions (e.g., flanges and lips), recesses, fillets, or chamfers that are complementary to or otherwise suitable for use with features of the body jewelry. In one embodiment, selecting a sleeve includes selecting a sleeve having an external size that is capable of being secured into the associated piercing hole. In one embodiment selecting a sleeve includes selecting a sleeve having features, such as flanges, troughs, protrusions, recesses, or the like, that suitable for securing the sleeve and body jewelry into the piercing hole.

In the illustrated embodiment, method 200 also includes installing the sleeve, as depicted at block 208. In one embodiment, installing the sleeve includes sliding the sleeve over the body jewelry. For example, where the body jewelry includes a post (e.g., a cylindrical) shaped body, a tubular shaped sleeve may be slid over the body. In one embodiment, the sleeve may have an internal size that is smaller than the external size of the body jewelry such that at least a portion of the sleeve may be stretched or clipped over the body. Such an embodiment may provide an interference fit that acts to secure the sleeve to the body jewelry. In one embodiment, the sleeve may be heat-shrunk around the body jewelry. For example, the sleeve may include at least a portion of heat-shrinkable material that reduces in size when it is heated. Accordingly, the sleeve may be paced about the body jewelry and heated to help secure it to the body jewelry. In one embodiment, an adhesive may be used to secure the sleeve to the body jewelry. In one embodiment, the body jewelry may be assembled about the sleeve. For example, in an embodiment that includes a removable flange (See FIG. 3C), the sleeve may be slid over the body of the body jewelry and the removable flange subsequently attached to secure the sleeve to the body jewelry. In one embodiment a length of sleeve may be wrapped about the body jewelry. For example, the sleeve may be wrapped one or more times about the body jewelry until the desired thickness is obtained such that the body jewelry system may be retained in the piercing hole. Other embodiments may include any combination of the above described techniques for installing the sleeve.

In the illustrated embodiment, method 200 also includes installing the body jewelry system, as depicted at block 212. In one embodiment, installing the body jewelry system includes securing the body jewelry and the installed sleeve into the piercing hole. Other embodiments may also include, when the piercing hole has expanded, removing the body system jewelry, removing the sleeve from the body jewelry and repeating at least method steps at blocks 204-212.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Furthermore, note that the word “may” is used throughout this application in a permissive sense (i.e., having the potential to, being able to), not a mandatory sense (i.e., must). The term “include”, and derivations thereof, mean “including, but not limited to”. As used in this specification, the singular forms “a”, “an” and “the” include plural referents unless the content clearly indicates otherwise. Thus, for example, reference to “a sleeve” includes a combination of two or more sleeves. The term “coupled” means “directly or indirectly connected”.

1. A method of modifying a size of body jewelry, comprising:
providing body jewelry configured to be disposed in a body piercing orifice, wherein the body jewelry comprises an exterior surface having an external size configured to fit securely within first body piercing orifice;
providing a sizing sleeve configured to be disposed about the exterior surface of the body jewelry, wherein the sizing sleeve comprises an inward facing interior surface configured to be disposed about the exterior surface of the body jewelry during use and an outward facing exterior surface configured to contact an interior of a body piercing orifice during use; and
disposing the sizing sleeve about the body jewelry, such that at least a portion of the interior surface of the sizing sleeve is disposed about at least a portion of the exterior surface of the body jewelry, wherein an external size of the sizing sleeve with the sizing sleeve disposed about the body jewelry is greater than the external size of the exterior surface of the body jewelry, and wherein external size of the sizing sleeve with the sizing sleeve disposed about the body jewelry is configured to fit securely within a second body piercing orifice that is larger than the first body piercing orifice.

2. The method of claim 1, wherein providing a sizing sleeve configured to be disposed about the exterior surface of the body jewelry, comprises providing a plurality of sizing sleeves, wherein each of the plurality of sizing sleeves is configured to be disposed about the exterior surface of the body jewelry, and wherein one or more of the plurality of sizing sleeves comprises an inward facing interior surface configured to be disposed about the external perimeter of the body jewelry during use and an outward facing exterior surface configured to contact an interior of a body piercing orifice during use.

3. (canceled)

4. The method of claim 1, further comprising:
removing the sizing sleeve from about the body jewelry; and
providing a second sizing sleeve configured to be disposed about the exterior surface of the body jewelry, wherein the second sizing sleeve comprises an external size that is larger than the external size of the other sizing sleeve, and wherein the second sleeve external size is configured to fit within a third body piercing orifice that is larger than the second body piercing orifice.

5. (canceled)

6. The method of claim 1, wherein disposing the sizing sleeve about the body jewelry comprises heat shrinking the sizing sleeve about the exterior surface of the body jewelry.

7. The method of claim 1, wherein disposing the sizing sleeve about the body jewelry comprises using an adhesive to secure the sizing sleeve about the exterior surface of the body jewelry.

8. (canceled)

9. The system of claim 1, wherein an internal size of the interior surface of the sizing sleeve is between about 95% and 105% of the external size of the exterior surface of the body jewelry and the external size of the exterior surface of the exterior sleeve is about between about 95%-105% the size of the body piercing orifice it is configured to fit into.

10. The system of claim 1, wherein the internal size of the interior surface of the sizing sleeve is between about 50% and 95% of the external size of the exterior surface of the body jewelry and the external size of the exterior surface of the exterior sleeve is greater than about 95% the size of the body piercing orifice it is configured to fit into.

11. A body jewelry system, comprising:
a sizing sleeve configured to be disposed about the exterior surface of the body jewelry, wherein the sizing sleeve comprises an inward facing interior surface configured to be disposed about the exterior surface of the body jewelry during use and an outward facing exterior surface configured to contact an interior of a body piercing orifice during use.

12. The system of claim 11, wherein the sizing sleeve comprises an elastic material configured to conform to a shape of the body jewelry during use.

13. The system of claim 11, wherein the exterior surface of the sizing sleeve comprises a recess that extends about at least a portion of the exterior surface and is located between a first edge and a second edge of the sizing sleeve.

14. The system of claim 13, wherein the sizing sleeve comprises a cylindrical shape and the recess comprises a trough that extends completely about a circumference of the cylindrically shaped sizing sleeve.

15. The system of claim 11, wherein the exterior surface of the sizing sleeve comprises a protrusion that extends about at least a portion of the exterior surface, and wherein the protrusion is configured to inhibit dislodging of the sizing sleeve from the body piercing orifice during use.

16. The system of claim 11, wherein the exterior surface of the sizing sleeve comprises a first protrusion that extends about at least a portion of the exterior surface and a second protrusion that extends about at least a portion of a second edge of the exterior surface, wherein the first protrusion is configured to be disposed on a first side of the body piercing orifice during use and the second protrusion is configured to be disposed on a second side of the body piercing orifice during use such that the first protrusion and the second protrusion are configured to inhibit dislodging of the sizing sleeve from the body piercing orifice during use.

17. The system of claim 11, further comprising body jewelry having an exterior surface shaped complementary to the interior surface shape of the sizing sleeve.

18. A jewelry kit, comprising:
a plurality of sizing sleeves configured to be disposed about an external surface of body jewelry, wherein each of the sizing sleeves comprises an inward facing interior surface configured to be disposed about the exterior surface of the body jewelry during use and an outward facing exterior surface configured to contact an interior of a body piercing orifice during use,
wherein one or more of the plurality of sizing sleeves has a size that is different from one or more of others of the plurality of sizing sleeves.

19. The jewelry kit of claim 18, wherein one or more of the plurality of sizing sleeves comprises a different size from the other of the plurality of sizing sleeves.

20. The jewelry kit of claim 18, wherein each of the plurality of sizing sleeves comprises an external size that is different from an external size of each of the other of the plurality of sizing sleeves.

21. The jewelry kit of claim 18, wherein each of the plurality of sizing sleeves comprise the same internal size and wherein one or more of the plurality of sizing sleeves comprise an external size that is different from an external size of each of the other of the plurality of sizing sleeves.

22. The jewelry kit of claim 18, wherein each of the plurality of sizing sleeves comprise the same internal size and wherein one or more of the plurality of sizing sleeves comprise an external size that is different from an external size of one or more of the other of the plurality of sizing sleeves.

23. The jewelry kit of claim 18, further comprising body jewelry having an external size, wherein each of the plurality of sizing sleeves comprise an internal size configured to fit about the exterior surface of the body jewelry, and wherein one or more of the plurality of sizing sleeves comprises an external size that is different from an external size of one or more of the other of the plurality of sizing sleeves.
